(19) United States
(12) Patent Application Publication
(10) Pub. No.: US 2007/0159440 A1
(43) Pub. Date: Jul. 12, 2007

(54) DATA LINE DRIVER CIRCUITS AND METHODS FOR INTERNALLY GENERATING A FRAME RECOGNITION SIGNAL

(75) Inventor: Chang-Sig Kang, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/621,602

(22) Filed: Jan. 10, 2007

(30) Foreign Application Priority Data
Jan. 10, 2006 (KR) 10-2006-0002878

(51) Int. Cl. G09G 3/36

(52) U.S. Cl. 345/99

(57) ABSTRACT

A data line driver includes a circuit that is configured to drive data lines of a display panel in response to digital image data, a horizontal start signal and a load signal. The circuit is further configured to internally generate a frame recognition signal from the horizontal start signal and the load signal. The circuit may also be configured to receive the digital input data, the horizontal start signal and the load signal from a timing controller. The data line driver circuit may be combined with the timing controller, a scan line driver and a display panel to provide a display device. Analogous display data line driving methods also may be provided.

### CROSS-REFERENCE TO RELATED APPLICATION

This application claims the benefit under 35 U.S.C. § 119 of Korean Patent Application No. 10-2006-0002878, filed on Jan. 10, 2006, the disclosure of which is hereby incorporated herein by reference in its entirety as if set forth fully herein.

### FIELD OF THE INVENTION

The present invention relates to display devices and methods, and more particularly, to display driving circuits and methods therefor.

### BACKGROUND OF THE INVENTION

Flat panel display devices, such as Liquid Crystal Display (LCD) devices, are widely used in many applications. FIG. 1 is a block diagram of a general display device. Referring to FIG. 1, the display device 10 includes a display panel 20, a timing controller 30, a data line driver (or a source driver) 40, and a scan line driver (or a gate driver) 50.

The display panel 20 includes a plurality of data lines (or source lines) Y1 to Yn, a plurality of scan lines (or gate lines) G1 to Gm, and a plurality of pixels, which may include thin film transistors, connected between the plurality of the data lines Y1 to Yn and the plurality of the scan lines G1 to Gm, respectively, and displays an image.

The timing controller 30 receives digital image data DATA and control signals such as a vertical synchronization signal Vsync and a horizontal synchronization signal Hsync, etc., outputs the digital image data DATA, a horizontal start signal DIO, and a load signal CLK1 to the data line driver 40, and outputs a vertical start signal (or a vertical synchronization start signal) STV to the scan line driver 50.

The vertical synchronization signal Vsync is a reference signal for one frame, and a display operation for one frame is performed during a period of a vertical synchronization signal Vsync. Generally, the vertical synchronization signal Vsync is a pulse that is activated when one frame of data has been transmitted to the display panel 20.

The horizontal synchronization signal Hsync is a reference signal for one line, i.e., a scan line, and a display operation for one line is performed during a period of the horizontal synchronization signal Hsync. Generally, the horizontal synchronization signal Hsync is a pulse that is activated when one line of data has been transmitted to the display panel 20.

The data line driver 40 drives a plurality of the data lines Y1 to Yn of the display panel 20 based on the digital image data DATA and the control signals DIO and CLK1 output from the timing controller 30.

The vertical start signal STV is a signal for selecting a first scan line G1. Generally, the scan line driver 50 drives the scan lines G1 to Gm sequentially when the vertical start signal STV is changed from a low level to a high level.

When a signal (hereinafter referred to as a “frame recognition signal”) such as the vertical start signal STV is used for recognition of a frame in the data line driver 40, a Printed Circuit Board (PCB) including a separate wire for transmitting the frame recognition signal to the data line driver 40 may be needed.

### SUMMARY OF THE INVENTION

Some embodiments of the present invention provide a data line driver that includes a circuit that is configured to drive a plurality of data lines of a display panel in response to digital image data, a horizontal start signal and a load signal. The circuit is further configured to internally generate a frame recognition signal from the horizontal start signal and the load signal. In other embodiments, the circuit is further configured to receive the digital input data, the horizontal start signal and the load signal from a timing controller. The data line driver circuit may be combined with the timing controller, a scan line driver and a display panel to provide a display device. Analogous display data line driving methods also may be provided according to other embodiments of the present invention.

According to yet other embodiments of the present invention, there is provided an apparatus for generating a frame recognition signal in a data line driver including a signal generation circuit that is configured to generate a signal, which makes a transition from a first logic state to a second logic state in response to a horizontal start signal and a transition from the second logic state to the first logic state in response to a delayed version of a load signal. A sampling circuit is configured to generate the frame recognition signal by sampling the output signal from the signal generation circuit in response to the load signal.

In some embodiments, the signal generation circuit may comprise an S-R latch including a set input terminal that is configured to receive the horizontal start signal as a set signal and a reset input terminal that is configured to receive the delayed version of the load signal as a reset signal. The sampling circuit may comprise a D flip-flop.

According to other embodiments of the present invention, there is provided a data line driver that includes a shift register that is configured to shift a horizontal start signal sequentially in response to a clock signal. A latch is configured to store digital image data in response to a signal output from the shift register and to output the digital image data in response to the load signal. A digital to analog converter is configured to select one of gray scale voltages in response to the digital image data output from the latch and to output analog voltages corresponding to the digital image data output from the latch. A buffer is configured to buffer the analog voltages output from the digital to analog converter and to supply the buffered analog voltages to data lines. A frame recognition signal generation circuit is configured to sample a first signal, which makes a transition from a first logic state to a second logic state in response to the horizontal start signal and a transition from the second logic state to the first logic state in response to the delayed version of the load signal. The frame recognition signal generation circuit is configured to sample the first signal in response to the load signal to generate a frame recognition signal.

According to still other embodiments of the present invention, there is provided a display device including a controller that is configured to generate digital image data for forming a selected image, and control signals including a clock signal, a horizontal start signal, and a load signal. A data line driver is configured to output data line driving signals for driving the data lines in response to gray scale voltages and the digital image data. A scan line driver is configured to output scan line driving signals for driving scan lines in response to the control signals and gate turn-on/off voltages. A display panel includes data lines and scan lines and is configured to display the image data in response to the data line driving signals and the scan line driving signals.

In some embodiments, the data line driver includes a shift register configured to shift the horizontal start signal sequentially in response to the clock signal. A latch is configured to store the digital image data in response to a signal output from the shift register and to output the digital image data in response to the load signal. A digital to analog converter is configured to select one of the gray scale voltages which are input in response to the digital image data output from the latch and to output analog voltages corresponding to the digital image data output from the latch. A buffer is configured to buffer the analog voltages output from the digital to analog converter and to supply the buffered analog voltages to the data lines. A frame recognition signal generation circuit is configured to sample a first signal, which has a transition from a first logic state to a second logic state in response to the horizontal start signal and a transition from the second logic state to the first logic state in response to a delayed version of the load signal. The frame signal generation circuit is also configured to sample the first signal in response to the load signal and to generate the frame recognition signal.

According to yet other embodiments of the present invention, there are provided methods for generating a frame recognition signal in a data line driver. The methods may include generating a signal making a transition from a first logic state to a second logic state in response to a horizontal start signal and a transition from the second logic state to the first logic state in response to a delayed version of a load signal, and generating the frame recognition signal by sampling the signal in response to the load signal.

### BRIEF DESCRIPTION OF THE DRAWINGS

The above and other features and advantages of the present invention will become more apparent by describing in detail the exemplary embodiments thereof with reference to the attached drawings in which:

FIG. 1 is a block diagram of a conventional display device.

FIG. 2 is a block diagram of an apparatus for generating a frame recognition signal according to some embodiments of the present invention.

FIG. 3 shows input/output waveforms of an apparatus for generating a frame recognition signal illustrated in FIG. 2.

FIG. 4 is a block diagram of a data line driver including an apparatus for generating a frame recognition signal according to some embodiments of the present invention.

FIG. 5 is a block diagram of a display device including an apparatus for generating a frame recognition signal according to some embodiments of the present invention.

FIG. 6 is a flowchart of methods of generating a frame recognition signal according to embodiments of the present invention.

### DETAILED DESCRIPTION OF THE INVENTION

The present invention is described more fully hereinafter with reference to the accompanying drawings, in which example embodiments of the invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art.

It will be understood that when an element is referred to as being “responsive to,” “from,” “connected to” or “coupled to” another element, it can be directly responsive, from, connected or coupled to the other element or intervening elements may be present. In contrast, when an element is referred to as being “directly responsive to,” “directly from,” “directly connected to” or “directly coupled to” another element or layer, there are no intervening elements present. Like numbers refer to like elements throughout. As used herein, the term “and/or” includes any and all combinations of one or more of the associated listed items and may be abbreviated as “/”.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes,” “including,” “have” and/or “having” when used in this specification, specify the presence of stated features, integers, steps, operations, elements, and/or components, but do not preclude the presence or addition of one or more other features, integers, steps, operations, elements, components, and/or groups thereof.

It should also be noted that in some alternate implementations, the functionality of a given block of the block diagrams/flowcharts may be separated into multiple blocks and/or the functionality of two or more blocks may be at least partially integrated.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

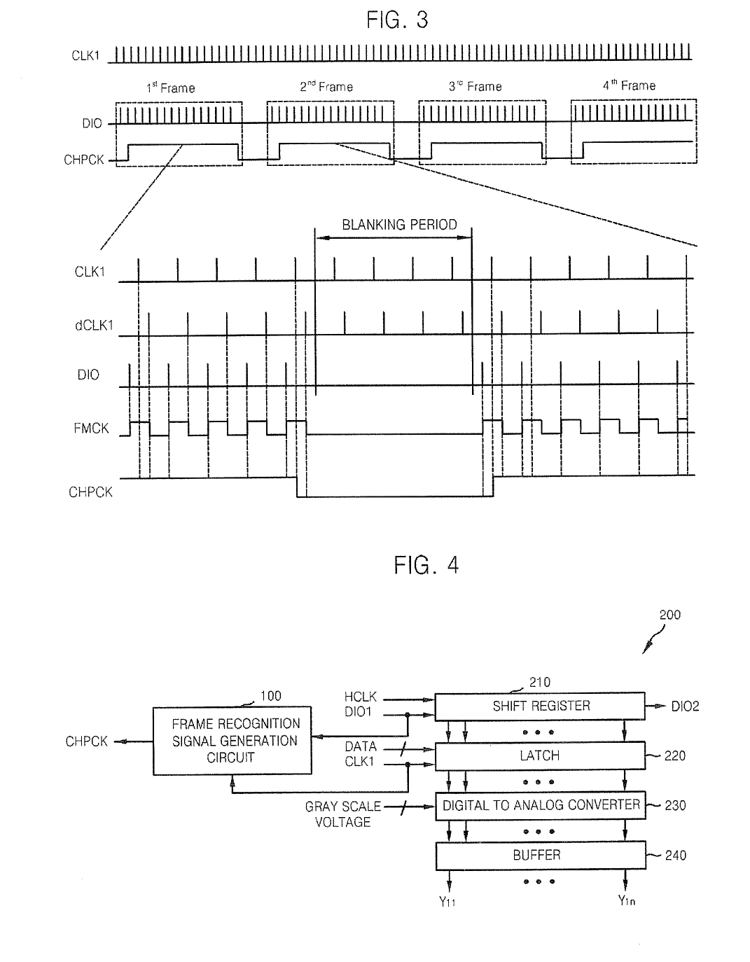

FIG. 2 is a block diagram of an apparatus for generating a frame recognition signal according to some embodiments of the present invention. FIG. 3 shows input/output waveforms of an apparatus for generating a frame recognition signal illustrated in FIG. 2. Referring to FIGS. 2 and 3, the apparatus 100 for generating frame recognition signal includes a delay circuit (or delay element) 110, a first signal generation circuit 120, and a second signal generation circuit 130.

The delay circuit 110 is configured to delay a load signal CLK1 for a predetermined time to provide a delayed version dCLK1 of the load signal CLK1. The first signal generation circuit 120 may be embodied by an S-R latch. The set signal input terminal S of the S-R latch 120 is configured to receive a horizontal start signal DIO and a reset signal input terminal R is configured to receive the delayed version dCLK1 of the load signal CLK1, i.e., an output signal dCLK1 of the delay circuit 110. The S-R latch 120 outputs a first signal FMCK. The first signal FMCK makes a transition to a high level when the horizontal start signal DIO is a high level or a logic of“1”. The first signal FMCK also makes a transition to a low level or a logic of “0” when the delayed version of load signal dCLK1 is a high level.

The second signal generation circuit 130 may be embodied by a D flip-flop, which is an example of a sampling circuit. The D flip-flop is configured to output a frame recognition signal CHPCK by sampling the output signal FMCK of the S-R latch 120 in response to a rising edge of the load signal CLK1.

The horizontal start signal DIO may also be referred to as a horizontal start pulse, a data start signal, a shift signal, etc. according to manufacturers producing data line drivers. The load signal CLK1 may also be referred to as a data latch signal or an output latch signal according to data line driver manufacturers.

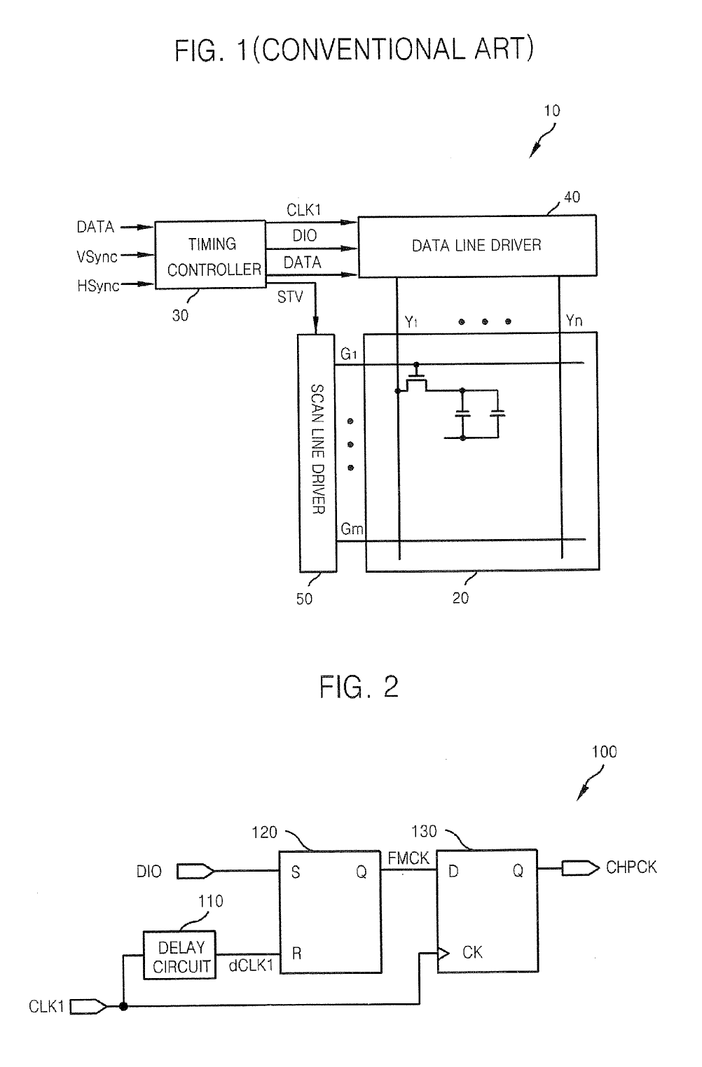

Referring to FIGS. 1 to 3, a timing controller 30 generally does not output the horizontal start signal DIO to the data line driver 40 during a period between frames, which is called a blanking period.

Therefore, when the load signal CLK1 is input to the reset signal input terminal R after a last horizontal start signal DIO of a first frame is input to the set signal input terminal S of the S-R latch 120, the S-R latch 120 outputs the first signal FMCK having a low level in the blanking period.

When the first horizontal start signal DIO of a second frame is input to the set signal input terminal S of the S-R latch 120, the first signal FMCK makes a transition from a low level to a high level.

When the D flip-flop 130 samples the output signal FMCK of the S-R latch 120 in response to a rising edge of the load signal CLK1, an output signal CHPCK of the D flip-flop 130 has a high level. Thus, the apparatus 100 for generating a frame recognition signal may generate the frame recognition signal CHPCK having the same period as a vertical start signal STV output to the scan line driver 50.

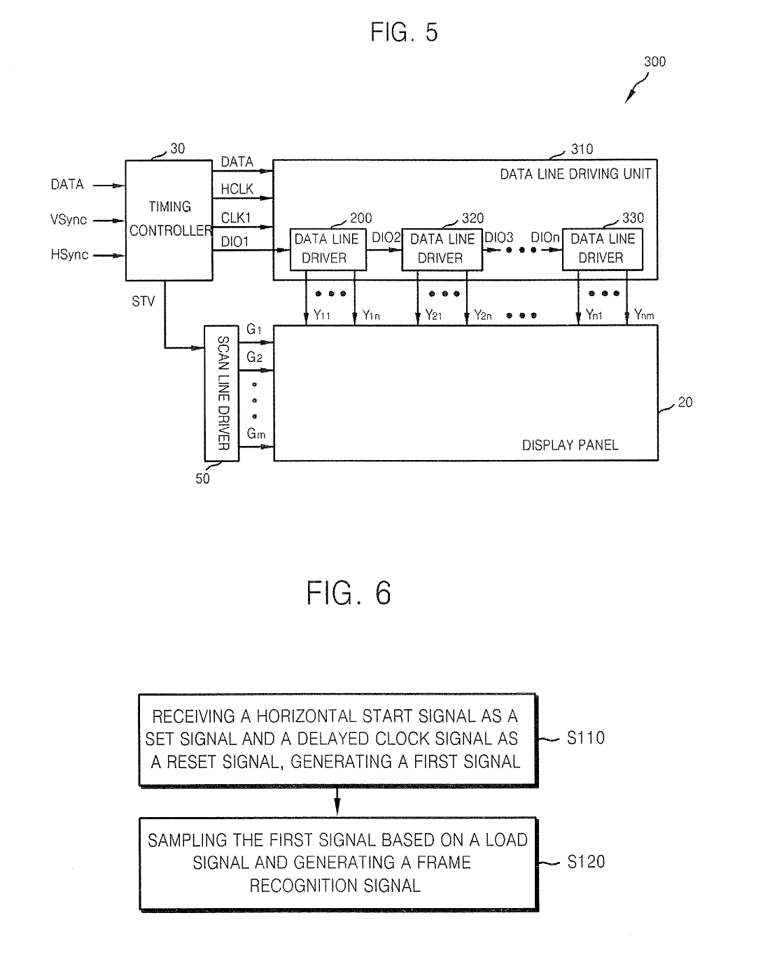

FIG. 4 is a block diagram of a data line driver including the apparatus 100 for generating a frame recognition signal according to some embodiments of the present invention, and FIG. 5 is a block diagram of a display device including an apparatus for generating a frame recognition signal according to some embodiments of the present invention. Referring to FIGS. 4 and 5, the data line driver 200 includes an apparatus 100 for generating a frame recognition signal (or a frame recognition signal generation circuit 100), a shift register 210, a latch 220, a digital to analog converter 230, and a buffer 240.

The frame recognition signal generation circuit 100 may be configured to generate a frame recognition signal CHPCK having the same period as the vertical start signal STV output to the scan line driver 50, in response to the horizontal start signal (DIO1) and the load signal CLK1.

The shift register 210 of the data line driver 200 includes a plurality of flip-flops (not shown) corresponding to a number of data lines Y11 to Y1n and each may be connected in series.

The shift register 210 is configured to store the horizontal start signal DIO1 synchronized with a horizontal clock signal HCLK, which is output from the timing controller 30, to shift the horizontal start signal DIO1 to adjacent flip-flops sequentially synchronized with the horizontal clock signal HCLK, and to output the shifted horizontal start signal DIO1 to a next data line driver 320 as a horizontal start signal DIO2. The data line driver 320 is configured to output the shifted horizontal start signal DIO2 to a next data line driver as a horizontal start signal DOI3.

The latch 220 is configured to store digital image data DATA synchronized with the horizontal start signals, which are shifted sequentially by flip-flops of the shift register 210, and to transmit the stored digital image data to the digital to analog converter 230 in parallel, in response to the load signal CLK1, which is output from the timing controller 30. According to some embodiments, the shift register 210 and the latch 20 may be implemented in one block.

The digital to analog converter 230 is configured to generate analog voltages supplied to the data lines Y11 to Y1n. In detail, the digital to analog converter 230 may be configured to select one of a plurality of gray scale voltages based on the digital image data output from the latch 220, and to generate analog voltages corresponding to the digital image data. The buffer 240 is configured to output analog voltages to the data lines after buffering analog voltages output from the digital to analog converter 230.

A display data line driving unit 310 in FIG. 5 includes a plurality of data line drivers (200, 320 . . . 330). Each of the data line drivers (200, 320, . . . , 330) may have the same structure. Also, the remaining data line drivers (320, . . . , 330) other than the first data line driver 200 may each include the shift register 210, the latch 220, the digital to analog converter 230, and the buffer 240.

Accordingly, FIGS. 2-5 illustrate data line drivers according to some embodiments of the invention that include a circuit that is configured to drive a plurality of data lines of a display panel in response to digital image data, a horizontal start signal and a load signal. The circuit is further configured to internally generate a frame recognition signal from the horizontal start signal and the load signal. The circuit may be further configured to receive the digital input data, the horizontal start signal and the load signal from a timing controller. The circuit may be combined with the timing controller, a scan line driver and a display panel to provide a display device. These figures also illustrate analogous display data line driving methods according to some embodiments of the invention.

FIG. 6 is a flowchart of methods for generating a frame recognition signal according to some embodiments of the present invention. Referring to FIGS. 2 to 5, an S-R flip-flop 120 receives a horizontal start signal (DIO1) as a set signal, receives the delayed version of a clock signal dCLK1 as a reset signal, and generates a first signal FMCK (Block S110).

The D flip-flop 130 generates a frame recognition signal CHPCK having the same period as a period of a vertical start signal STV, which is supplied to the scan line driver 50, after sampling a output signal FMCK of the S-R flip-flop 120 in response to a load signal CLK1 (Block S120).

According to some embodiments of the present invention, an apparatus for generating a frame recognition signal may be implemented in a data line driver, or the display device may generate a signal capable of recognizing a frame based on control signals output from a conventional timing controller, such as a horizontal start signal and a load signal. An added PCB line may not be needed.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. An apparatus for generating a frame recognition signal in a data line driver comprising:
a signal generation circuit that is configured to generate an output signal making a transition from a first logic state to a second logic state in response to a horizontal start signal, and a transition from the second logic state to the first logic state in response to a delayed version of a load signal; and
a sampling circuit that is configured to sample the output signal from the signal generation circuit in response to the load signal to generate the frame recognition signal.

2. The apparatus according to claim 1, wherein the signal generation circuit comprises an S-R latch having a set input terminal that is configured to receive the horizontal start signal as a set signal, and a reset input terminal that is configured to receive the delayed version of the load signal as a reset signal.

3. The apparatus according to claim 1, wherein the sampling circuit comprises a D flip-flop having an input terminal that is configured to receive the output signal from the signal generation circuit and a clock input that is configured to receive the load signal.

4. A data line driver comprising:
a shift register that is configured to shift a horizontal start signal sequentially in response to a clock signal;
a latch that is configured to store digital image data in response to a signal output from the shift register, and to output the stored digital image data in response to a load signal;
a digital to analog converter that is configured to select one of gray scale voltages in response to the digital image data output from the latch, and to output analog voltages corresponding to the digital image data output from the latch;
a buffer that is configured to buffer the analog voltages output from the digital to analog converter and to supply the buffered analog voltages to data lines; and
a frame recognition signal generation circuit that is configured to sample a first signal, which makes a transition from a first logic state to a second logic state in response to the horizontal start signal and a transition from the second logic state to the first logic state in response to a delayed version of the load signal, the frame signal generation circuit configured to sample the first signal in response to the load signal to generate a frame recognition signal.

5. The data line driver according to claim 4, wherein the frame recognition signal generation circuit comprises:
a delay circuit that is configured to generate the delayed version of the load signal by delaying the load signal;
a signal generation circuit that is configured to receive the horizontal start signal as a set signal, to receive an output signal of the delay circuit as a reset signal, and to generate the first signal; and
a sampling circuit that is configured to sample the first signal in response to the load signal and to output the frame recognition signal.

6. A data line driver according to claim 4 in combination with:
a controller that is configured to generate digital image data for forming a selected image, and control signals including the clock signal, the horizontal start signal and the load signal;
a scan line driver that is configured to output scan line driving signals for driving scan lines in response to the control signals and gate turn-on/off voltages; and
a display panel including data lines and scan lines and configured to display the image data in response to the buffered analog voltages that are supplied to the data lines and the scan line driving signals that are supplied to the scan lines to provide a display device.

7. The data line driver according to claim 6, wherein the frame recognition signal generation circuit comprises:
a delay circuit that is configured to generate the delayed version of the load signal by delaying the load signal;
a signal generation circuit that is configured to receive the horizontal start signal as a set signal, to receive an output signal of the delay circuit as a reset signal, and to generate the first signal; and
a sampling circuit that is configured to sample the first signal in response to the load signal and to output the frame recognition signal.

8. A method for generating a frame recognition signal in a data line driver comprising:
generating a signal making a transition from a first logic state to a second logic state in response to a horizontal start signal and a transition from the second logic state to the first logic state in response to a delayed version of a load signal; and
generating the frame recognition signal by sampling the signal in response to the load signal.

9. A data line driver comprising:
a circuit that is configured to drive a plurality of data lines of a display panel in response to digital image data, a horizontal start signal and a load signal, the circuit being further configured to internally generate a frame recognition signal from the horizontal start signal and the load signal.

10. A data line driver according to claim 9, wherein the circuit is further configured to receive the digital image data, the horizontal start signal and the load signal from a timing controller.

11. A data line driver according to claim 9 in combination with a timing controller, a scan line driver and a display panel to provide a display device.

12. A display data line driving method comprising:
driving plurality of data lines of a display panel in response to digital image data, a horizontal start signal and a load signal; and
internally generating a frame recognition signal from the horizontal start signal and the load signal.

13. A method according to claim 12, further comprising:
receiving the digital image data, the horizontal start signal and the load signal from a timing controller.
